(19) United States
(12) Patent Application Publication
(10) Pub. No.: US 2025/0256473 A1
(43) Pub. Date: Aug. 14, 2025

(54) CARBON-FIBER FIXATION JIG, METHOD FOR MANUFACTURING CARBON-FIBER REINFORCED RESIN PIPE BODY, AND POWER TRANSMISSION SHAFT

(71) Applicant: Hitachi Astemo, Ltd., Ibaraki (JP)

(72) Inventor: Kazuhide KOGUCHI, Ibaraki (JP)

(21) Appl. No.: 18/843,992

(22) PCT Filed: Mar. 29, 2022
(86) PCT No.: PCT/JP2022/015364

§ 371 Date: Apr. 21, 2025

(51) Int. Cl. B29C 70/54; B29C 70/32; B29K 307/04; B29L 31/00; F16C 3/02

(52) U.S. Cl. CPC B29C 70/543; F16C 3/026; B29C 70/32; B29K 2307/04; B29L 2031/75; F16C 2208/02

(57) ABSTRACT

A carbon-fiber fixation jig is provided to implement efficiently removing unnecessary portions of carbon fibers while a carbon-fiber reinforced resin pipe body is manufactured. A jig (60A) is attached to a first metal member (40A), which is set to have a carbon-fiber layer (31) wound around an outer circumferential surface thereof, at an axial end of said outer circumferential surface, so as to be non-rotatable relative to each other, wherein the jig includes a first recess (62a) at a boundary with said outer circumferential surface, the recess having a diameter smaller than said outer circumferential surface.

### TECHNICAL FIELD

The present invention relates to a carbon-fiber fixation jig used when a fiber reinforced resin pipe body is manufactured, with carbon fibers wound around outer circumferential surfaces of a mandrel and metal members provided at ends of the mandrel, a method for manufacturing a carbon-fiber reinforced resin pipe body, and a power transmission shaft.

### BACKGROUND OF THE INVENTION

Filament winding (FW) is used as a technique to manufacture a tube body (shaft member) with carbon-fiber reinforced resin. FW involves winding resin-impregnated carbon fibers individually around a core member and heating them, to form a tube body.

Such a technique of winding carbon fibers around a core member is described in Patent Documents 1 and 2 that jigs each having a plurality of radially oriented pins are provided at ends of the core member, and the fibers are hooked around the pins and wound around the core member. With this technique, jigs are attached to the core member, so as to be non-rotatable relative to each other, and not to be moved in an axial direction, to prevent the carbon fibers wound around the core member from being moved in a rotational direction or the axial direction in subsequent steps.

In addition, multi-thread filament winding (MFW) is described in Patent Document 3. MFW involves winding a plurality of carbon fibers at one time around an outer circumferential surface of a core member, to allow for improving productivity.

In order to manufacture a product having metal joint members provided at ends of a shaft member, the technique described in Patent Document 3 involves winding and layering carbon fibers, with ends of an assembly of a core member and the joint members fixed, with a metal tape or the like, onto the outer circumferential surface of the joint members. Next, the assembly provided with the carbon fibers is placed in a mold and a resin transfer molding (RTM) of impregnating the carbon fibers with resin and curing the resin by heat treatment is used to manufacture a shaft member provided with joint members.

### PRIOR ART DOCUMENT

### Patent Document

Patent Document 1, Japanese Patent Application Publication No. 2000-102983 A;
Patent Document 2, Japanese Patent Application Publication No. H07-205317 A; and
Patent Document 3, Japanese Patent No. 6873369 B1.

### SUMMARY OF THE INVENTION

### Problems to be Solved

The technique of Patent Document 3 includes a step of removing the carbon fibers on the outer circumferential surfaces of the joint members. Here, as a pipe body made of the carbon fibers impregnated with resin is elongated, the pipe body needs to be set in a finishing machine to have unnecessary portions of the carbon fibers removed for finishing, so that it is desired to improve productivity.

The present invention has been devised in order to solve such problems, and is intended to provide a carbon-fiber fixation jig to allow for efficiently removing unnecessary portions of carbon fibers when manufacturing a carbon-fiber reinforced resin pipe body, a method for manufacturing a carbon-fiber reinforced resin pipe body, and a power transmission shaft.

### Solution to Problems

The present disclosure provides a carbon-fiber fixation jig to be attached to a metal member, which is set to have carbon fibers wound around an outer circumferential surface thereof, at an axial end of said outer circumferential surface, so as to be non-rotatable relative to each other, wherein the jig includes a first small-diameter section at a boundary with said outer circumferential surface, the section having a diameter smaller than said outer circumferential surface.

### Advantageous Effects of the Invention

According to the present invention, unnecessary portions of fibers are efficiently removed at a time of manufacturing a fiber reinforced resin pipe body.

### BRIEF DESCRIPTION OF DRAWINGS

FIG. 1 is a schematic cross-sectional view of a mandrel according to a first embodiment of the present invention;

FIG. 2 is a diagram schematically showing a power transmission shaft manufactured using a mandrel according to the first embodiment of the present invention;

FIG. 3 is a schematic cross-sectional view of a power transmission shaft according to the first embodiment of the present invention;

FIG. 4 is a schematic cross-sectional view of a jig assembly, at a first metal member, according to the first embodiment of the present invention;

FIG. 5 is a cross-sectional view, taken along a line V-V in FIG. 4;

FIG. 6 is a cross-sectional view, taken along a line VI-VI in FIG. 4;

FIG. 7 is a cross-sectional view, taken along a line VII-VII in FIG. 4;

FIG. 8 is a schematic cross-sectional view of the jig assembly, at a second metal member, according to the first embodiment of the present invention;

FIG. 9 is a flowchart of a method for manufacturing a power transmission shaft according to the first embodiment of the present invention;

FIG. 10 is a schematic cross-sectional view to illustrate the method for manufacturing the power transmission shaft according to the first embodiment of the present invention;

FIG. 11 is a schematic cross-sectional view to illustrate the method for manufacturing the power transmission shaft according to the first embodiment of the present invention;

FIG. 12 is a schematic cross-sectional view to illustrate the method for manufacturing the power transmission shaft according to the first embodiment of the present invention;

FIG. 13 is a schematic cross-sectional view to illustrate the method for manufacturing the power transmission shaft according to the first embodiment of the present invention;

FIG. 14 is a schematic cross-sectional view to illustrate the method for manufacturing the power transmission shaft according to the first embodiment of the present invention;

FIG. 15 is a schematic cross-sectional view to illustrate the method for manufacturing the power transmission shaft according to the first embodiment of the present invention;

FIG. 16 is a schematic cross-sectional view to illustrate the method for manufacturing the power transmission shaft according to the first embodiment of the present invention;

FIG. 17 is a schematic cross-sectional view of a jig assembly according to a modification to the first embodiment of the present invention;

FIG. 18 is a cross-sectional view, taken along a line XVIII-XVIII in FIG. 17;

FIG. 19 is a schematic cross-sectional view of a jig assembly according to a second embodiment of the present invention;

FIG. 20 is a cross-sectional view, taken along a line XX-XX in FIG. 19;

FIG. 21 is a schematic cross-sectional view of a jig assembly according to a modification to the second embodiment of the present invention; and

FIG. 22 is a schematic cross-sectional view of a jig assembly according to a third embodiment of the present invention.

### EMBODIMENTS OF THE INVENTION

Embodiments of the present invention are described in detail with reference to the drawings, taking a case of manufacturing a power transmission shaft (propeller shaft) of a vehicle, as an example of a fiber reinforced resin pipe body, from carbon-fiber reinforced plastic. In the following description, the same elements are denoted by the same reference numerals, and duplicate descriptions are omitted. Additionally, the referred drawings are deformed for the purpose of illustration.

### First Embodiment

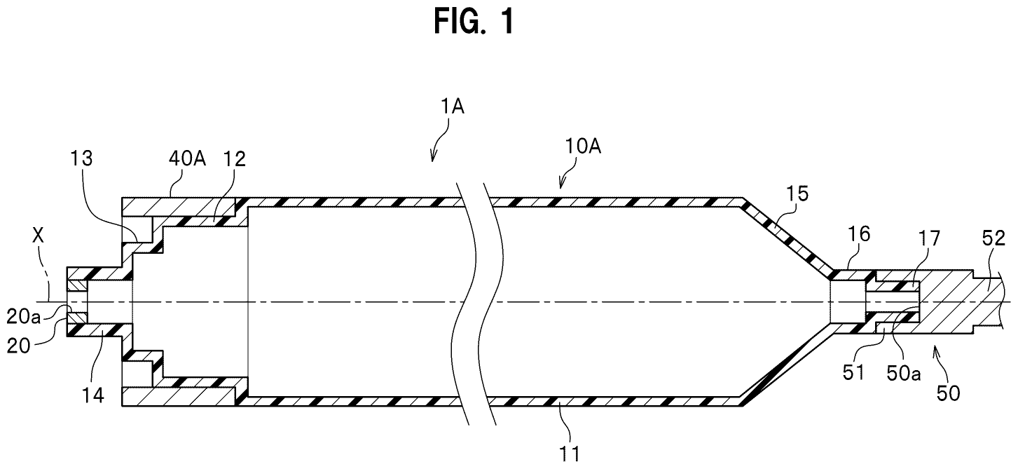

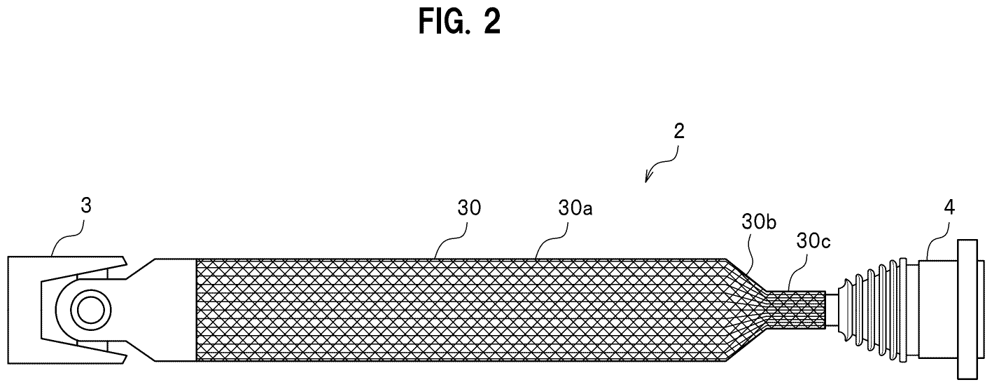

A mandrel 1A according to a first embodiment of the present invention is used for manufacturing a fiber reinforced resin pipe body 30 (see FIG. 2), and includes a mandrel body 10A and a fitted-into member 20, as shown in FIG. 1.

### <Mandrel Body>

The mandrel body 10A is a resin member having a cylindrical shape. The mandrel body 10A may be made of a material that can withstand heating while resin of the fiber reinforced resin pipe body 30 being cured. Examples of such materials include PP (polypropylene resin), PET (polyethylene terephthalate resin), SMP (shape memory polymer). The mandrel body 10A includes as a single member: a large-diameter section 11 at a center in an axial direction thereof; a first end having a first stepped section 12, a second stepped section 13, and a first small-diameter section 14 in an order from the large-diameter section 11; and a second end having a tapered section 15, a second small-diameter section 16, and a protruding section 17 in an order from the large-diameter section 11.

An outer diameter of the first stepped section 12 is smaller than that of the large-diameter section 11 by a radial dimension of a first metal member 40A. An outer diameter of the second stepped section 13 is smaller than that of the first stepped section 12. An outer diameter of the first small-diameter section 14 is smaller than that of the second stepped section 13. An outer diameter of the tapered section 15 decreases from the large-diameter section 11 toward the second small-diameter section 16. Size relationship between outer diameters of the first small-diameter section 14 and second small-diameter section 16 can be suitably set. An outer diameter of the protruding section 17 is smaller than that of the second small-diameter section 16.

The first stepped section 12, second stepped section 13, and first small-diameter section 14 of the present embodiment constitute the first end of the mandrel body 10A. Likewise, the tapered section 15, the second small-diameter section 16, and the protruding section 17 constitute the second end of the mandrel body 10A. The large-diameter section 11 constitutes a body section between the first and second ends that is radially inflated (increases in diameter) and then deflated (decreases in diameter). The first and second ends are not inflated in an inflation step to be described below, and an outer diameter of the second end (the tapered section 15 except an end next to the large-diameter section 11, the second small-diameter section 16, and the protruding section 17) is smaller, prior to the inflation step, than that of an first end (first stepped section 12) through which the mandrel body 10A is pulled out of the fiber reinforced resin pipe body 30.

### <Fitted-into Member>

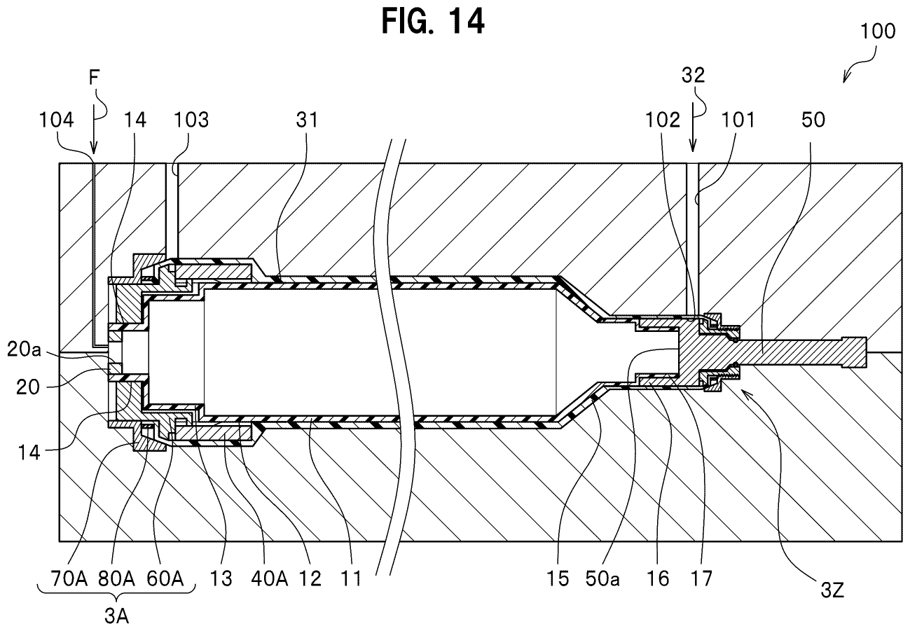

The fitted-into member 20 is a cylindrical metal member fitted into the first small-diameter section 14 of the first end of the mandrel body 10A. The fitted-into member 20 prevents the first small-diameter section 14 from being deformed radially inward, and is formed with a flow path 20a through which pressurizing fluid F (see FIG. 14) (e.g., pressurized air) is filled into the mandrel body 10A. The pressurizing fluid F of the present embodiment is used in a molding apparatus 100 for pressurizing from inside to inflate (increase in diameter) the mandrel body 10A. The pressurizing fluid F also works as heating fluid to heat a thermosetting resin (resin 32 to be described below) on an outer circumferential surface of the mandrel body 10A in the molding apparatus 100 to be described below. Note that the mandrel 1A may be a metal member having the mandrel body 10A formed with the fitted-into member 20, as a single member.

### <Power Transmission Shaft>

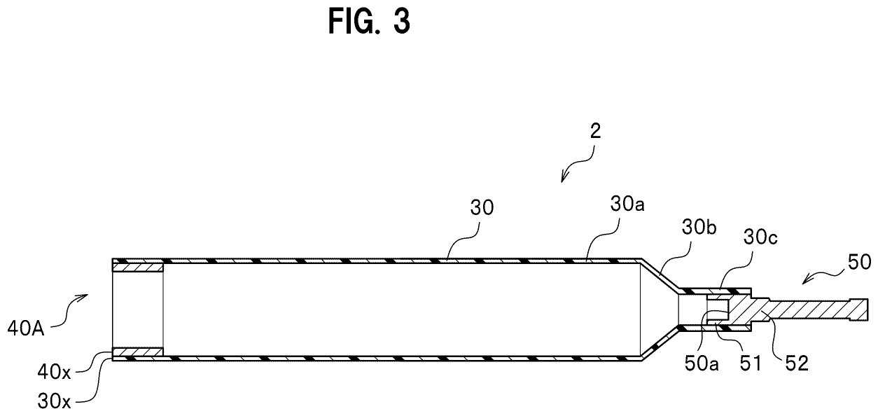

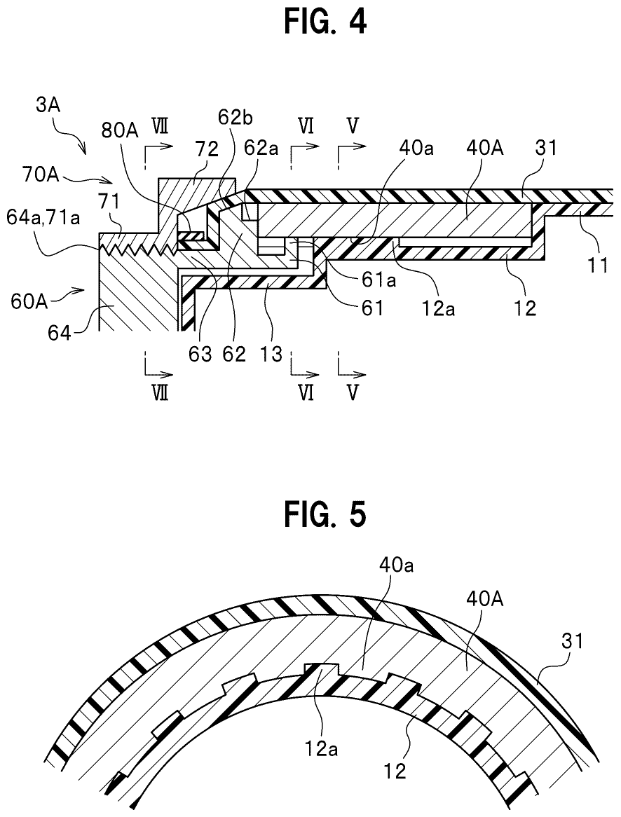

A power transmission shaft 2 manufactured with the mandrel 1A (see FIG. 1) runs in a front-rear direction of a vehicle and transmits power generated by a power source as rotation about an axis thereof, as shown in FIGS. 2 and 3. The power transmission shaft 2 includes the fiber reinforced resin pipe body 30, the first metal member 40A, a second metal member 50, a first joint member 3, and a second joint member 4. Note that the first joint member 3 and second joint member 4 are not shown in FIG. 4.

### <Fiber Reinforced Resin Pipe Body>

The fiber reinforced resin pipe body 30 is made of a resin impregnated fiber layer formed into a pipe shape so as to run along an outer circumferential surface of the mandrel body 10A. The fiber reinforced resin pipe body 30 is molded as a single member, together with the first metal member 40A and second metal member 50. The fiber reinforced resin pipe body 30 is formed so as to run along outer circumferential surfaces of: the large-diameter section 11 (see FIG. 1), tapered section 15 (see FIG. 1) and second small-diameter section 16 (see FIG. 1) of the mandrel body 10A; an axial end (next to the large-diameter section 11) of the first metal member 40A; and an axial end (next to the large-diameter section 11) of the second metal member 50. The fiber reinforced resin pipe body 30 includes as a carbon-fiber layer 31 (see FIG. 4): a first carbon-fiber layer; a second carbon-fiber layer; and a third carbon-fiber layer, in an order from radially inside (closer to the mandrel body 10A). Note that the other axial end of the second metal member 50 (on an opposite side to the large-diameter section 11) has an outer circumferential surface thereof not covered with the fiber reinforced resin pipe body 30, and protrudes from the fiber reinforced resin pipe body 30.

### <<First Carbon-Fiber Layer>>

The first carbon-fiber layer is composed of a plurality of carbon fibers provided on the outer circumferential surface of the mandrel body 10A (see FIG. 1) and the like so as to cover the mandrel body 10A. More specifically, a plurality of carbon fibers are gathered into a band or a bundle to form a carbon-fiber aggregate, and a plurality of the carbon-fiber aggregates are provided circumferentially at equal intervals, to form the first carbon-fiber layer. The carbon fibers of the first carbon-fiber layer runs parallel to the axial direction of the mandrel body 10A. That is, an orientation angle of the carbon fibers of the first carbon-fiber layer is zero degrees with respect to an axis X of the mandrel body 10A.

### <<Second Carbon-Fiber Layer>>

The second carbon-fiber layer is provided on a radially outer side of the first carbon-fiber layer, and is composed of a plurality of carbon fibers provided so as to cover the first carbon-fiber layer. More specifically, a plurality of carbon fibers are gathered into a band or a bundle to form a carbon-fiber aggregate, and a plurality of the carbon-fiber aggregates are provided circumferentially at equal intervals, to form the second carbon-fiber layer. The carbon fibers of the second carbon-fiber layer are wound one or more turns at an angle of 45 degrees with respect to the axial direction of the mandrel body 10A (see FIG. 1), so as to run in a spiral shape with respect to the axial direction of the mandrel body 10A. That is, an orientation angle of the carbon fibers of the second carbon-fiber layer is 45 degrees with respect to the axis X of the mandrel body 10A.

### <<Third Carbon-Fiber Layer>>

The third carbon-fiber layer is provided on a radially outer side of the second carbon-fiber layer, and is composed of a plurality of carbon fibers provided so as to cover the second carbon-fiber layer. More specifically, a plurality of carbon fibers are gathered into a band or a bundle to form a carbon-fiber aggregate, and a plurality of the carbon-fiber aggregates are provided circumferentially at equal intervals, to form the third carbon-fiber layer. The carbon fibers of the third carbon-fiber layer are wound one or more turns at an angle of minus 45 degrees with respect to the axial direction of the mandrel body 10A (see FIG. 1), so as to run in a spiral shape with respect to the axial direction of the mandrel body 10A. That is, an orientation angle of the carbon fibers of the third carbon-fiber layer is minus 45 degrees with respect to the axis X of the mandrel body 10A. Note that the first carbon-fiber layer, second carbon-fiber layer, and third carbon-fiber layer may be wound individually or may be wound simultaneously with respect to the mandrel body 10A.

As shown in FIGS. 2 and 3, the fiber reinforced resin pipe body 30 has a tapered section 30b decreasing in diameter from a large-diameter section 30a at the center in the axial direction thereof toward a small-diameter section 30c at the second end thereof. The large-diameter section 30a is a body section having a shape to follow the outer circumferential surface of the large-diameter section 11 (see FIG. 1) of the mandrel body 10A. The tapered section 30b has a shape to follow the outer circumferential surface of the tapered section 15 (see FIG. 1) of the mandrel body 10A. The small-diameter section 30c is an end having a shape to follow the second small-diameter section 16 (see FIG. 1) of the mandrel body 10A and a part of the outer circumferential surface of the second metal member 50.

### <First Metal Member and First Joint Member>

The first metal member 40A is a member having a substantially cylindrical shape. During manufacturing, the first metal member 40A is fitted onto the first stepped section 12 (see FIG. 1). The first metal member 40A has an axial dimension larger than the first stepped section 12, and the axial dimension of the present embodiment is equal to a sum of axial dimensions of the first stepped section 12 and second stepped section 13 (see FIG. 1). That is, the first metal member 40A covers the second stepped section 13, at a distance, by an end portion thereof from radially outside. The first metal member 40A has an inner circumferential surface thereof formed with a female spline 40a, axially end-to-end, to engage with a male spline 12a of an outer circumferential surface of the first stepped section 12 (see FIG. 5). The first metal member 40A is a member of the first joint member (yoke assembly) 3 of the power transmission shaft 2. The first joint member (yoke assembly) 3 is formed by assembling a trunnion, needle bearings, and a yoke (none of these are shown) to the first metal member 40A.

### <Second Metal Member and Second Joint Member>

The second metal member 50 is a member (shaft) having a substantially cylindrical shape. During manufacturing, the second metal member 50 is fitted onto the protruding section 17 (see FIG. 1).

As shown in FIGS. 1 and 3, the second metal member 50 is formed, at the other axial end thereof, with a bottomed hole 50a into which the protruding section 17 of the mandrel body 10A can be inserted. The second metal member 50 includes, as a single member, a fitted-onto portion 51 to be fitted onto the protruding section 17 and an axle section 52 to axially extend from the fitted-onto portion 51. An outer diameter of the axle section 52 is smaller than that of the fitted-onto portion 51.

The second metal member 50 is a part of the second joint member (plunge joint assembly) 4 of the power transmission shaft 2. The second joint member (plunge joint assembly) 4 is formed by assembling a boot and a plunge joint (either one is not shown) to the second metal member 50.

### <Jig Assembly (at First Metal Member)>

A jig assembly 3A according to the first embodiment of the present invention is used at the first metal member 40, and includes a jig 60A, a fixation member 70A, and an end fixation member 80A, as shown in FIG. 4.

### <<Jig>>

The jig 60A is a carbon-fiber fixation jig attached to the first metal member 40A during manufacturing the fiber reinforced resin pipe body 30 (see FIG. 2), so as to be non-rotatable relative to each other, and having an end portion of the carbon-fiber layer 31 set and fixed on an outer circumferential surface thereof. The jig 60A is a metal member in a cylindrical shape, and includes, as a single member, a first end section 61, a large-diameter section 62, a small-diameter section 63, and a second end section 64 in an axial order.

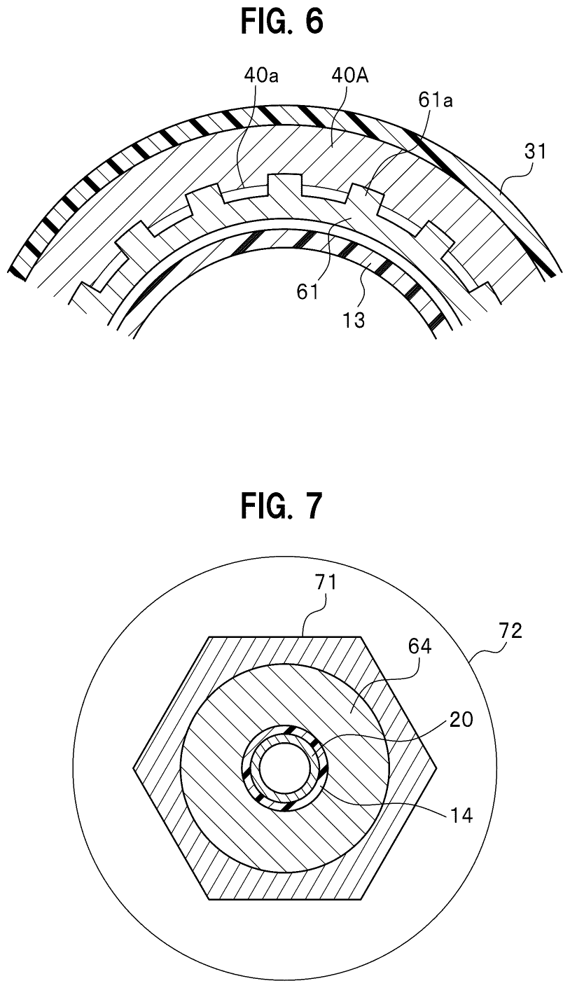

The first end section 61 is positioned closer to the center in the axial direction of the mandrel 1A (see FIG. 1), and is attached to the first metal member 40A, so as to be non-rotatable relative to each other. The first end section 61 is fitted onto the second stepped section 13 of the mandrel body 10A. The first end section 61 has an outer circumferential surface thereof formed with a male spline 61a to engage with the female spline 40a of the first metal member 40A (see FIG. 6).

The large-diameter section 62 is positioned between the first end section 61 and the second end section 64 and is closer to the first end section 61, to have the carbon-fiber layer 31 wound therearound. The large-diameter section 62 is fitted onto the second stepped section 13 of the mandrel body 10A (see FIG. 1). The large-diameter section 62 is axially external to the first metal member 40A, and has an end surface thereof, next to the first end section 61, set to abut against an end surface of the first metal member 40A. The large-diameter section 62 includes, at a portion thereof next to the first end section 61, a recess 62a recessed radially inward. The recessed 62a opens in the axial direction, and a bottom surface (radially outer end surface) thereof defines a first small-diameter section which is smaller in diameter than the large-diameter section 62. The recess 62a defines an annular groove, together with the end surface of the first metal member 40A. The other section, closer to the second end section 64, of the large-diameter section 62 includes an inclined surface 62b decreasing in diameter toward the second end section 64.

The small-diameter section 63 is positioned between the first end section 61 and the second end section 64 and is closer to the second end section 64, to have an end of the carbon-fiber layer 31 set thereon and fixed by the end fixation member 80A. An outer diameter of the small-diameter section 63 is smaller than that of the large-diameter section 62. The small-diameter section 63 is fitted onto the second stepped section 13 of the mandrel body 10A.

The second end section 64 is positioned at an end axially opposite to the first end section 61, and has the fixation member 70A attached thereto (screwed thereonto). The second end section 64 is fitted onto the first small-diameter section 14 of the mandrel body 10A. The second end portion 64 is formed, on an outer circumferential surface thereof, with a male thread 64a.

### <<Fixation Member>>

The fixation member 70A is a metal member in a cylindrical shape, and includes as a single member, a small-diameter section 71 and a large-diameter section 72 extending from the small-diameter section 71 toward the center in the axial direction of the mandrel 1A.

The small-diameter section 71 is fitted onto the second end section 64 of the jig 60A. The small-diameter section 71 is formed in an inner circumferential surface thereof with a female thread 71a into which the male thread 64a of the jig 60A is screwed. An outer circumferential surface of the small-diameter section 71 has a hexagonal shape when axially viewed (see FIG. 7).

The large-diameter section 72 is fitted onto the inclined surface 62b of the large-diameter section 62 of the jig 60A. The large-diameter section 72 has an inner diameter larger than the small-diameter section 71. The large-diameter section 72 has an inner circumferential surface inclined along the inclined surface 62b, and holds the carbon-fiber layer 31 to the inclined surface 62b with said inner circumferential surface.

### <<End Fixation Member>>

The end fixation member 80A is a tape or band made of metal wound, at an outer circumferential surface of the small-diameter section 63, on an outer circumferential surface of the end of the carbon-fiber layer 31, to temporarily fix the end of the carbon-fiber layer 31. The end fixation member 80A fixes the carbon-fiber layer 31 to the small-diameter section 71 so as to restrict at least the end of the carbon-fiber layer 31 moving in the axial direction. Note that the end fixation member 80A may not be required if the carbon-fiber layer 31 can be fixed only with the fixation member 70A.

### <Jig Assembly (at Second Metal Member)>

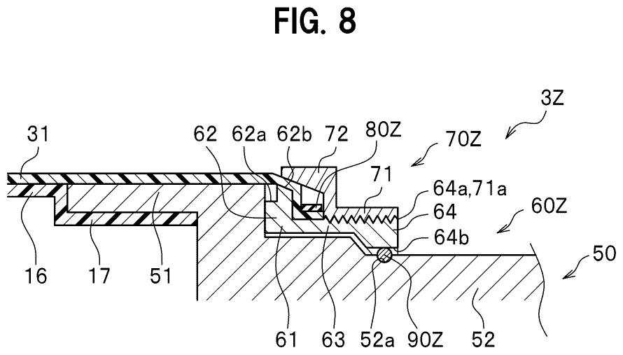

A jig assembly 3Z according to the first embodiment of the present invention is used at the second metal member 50, and includes a jig 60Z, a fixation member 70Z, an end fixation member 80Z, and a rotation restriction member 90Z, as shown in FIG. 8.

### <<Jig>>

The jig 60Z is a carbon-fiber fixation jig attached to the second metal member 50, so as to be non-rotatable relative to each other, during manufacturing the fiber reinforced resin pipe body 30, and having an end portion of the carbon-fiber layer 31 provided and fixed on an outer circumferential surface thereof. The jig 60Z is a metal member in a cylindrical shape, and includes, as a single member, a first end section 61, a large-diameter section 62, a small-diameter section 63, and a second end section 64 in an axial order.

The first end section 61 is positioned closer to the center in the axial direction of the mandrel 1A (see FIG. 1). The first end portion 61 is fitted onto the axle section 52 of the second metal member 50.

The large-diameter section 62 is positioned between the first end section 61 and the second end section 64 and is closer to the first end section 61, to have the carbon-fiber layer 31 wound therearound. The large-diameter section 62 is fitted onto the axle section 52 of the second metal member 60. The large-diameter section 62 has an end surface thereof closer to the first end section 61 to abut against a radially extending end surface at a boundary between the fitted-onto section 51 and axle section 52 of the second metal member 50.

The small-diameter section 63 is between the first end section 61 and the second end section 64 and is closer to the second end section 64, to have an end of the carbon-fiber layer 31 set thereon and fixed by the end fixation member 80Z. An outer diameter of the small-diameter section 63 is smaller than that of the large-diameter section 62. The small-diameter section 63 is fitted onto the axle section 52 of the second metal member 60.

The second end section 64 is an end axially opposite to the first end section 61, and is attached to the second metal member 50, so as to be non-rotatable relative to each other, and has the fixation member 70Z attached thereto (screwed thereonto). The second end section 64 is fitted onto the axle section 52 of the second metal member 60. The second end section 64 is formed on an outer circumferential surface thereof with a male thread 64a. The second end section 64 is formed in an inner circumferential surface thereof with a groove 64b extending in the axial direction.

### <<Fixation Member>>

The fixation member 70Z is a metal member in a cylindrical shape, and includes as a single member, a small-diameter section 71 and a large-diameter section 72 extending from the small-diameter section 71 toward the center in the axial direction of the mandrel 1A.

The small-diameter section 71 is screwed onto the second end section 64 of the jig 60Z. The small-diameter section 71 is formed in an inner circumferential surface thereof with a female thread 71a into which the male thread 64a of the jig 60Z is screwed. An outer circumferential surface of the small-diameter section 71 has a hexagonal shape when axially viewed.

The large-diameter section 72 is fitted onto the inclined surface 62b of the large-diameter section 62 of the jig 60Z. The large-diameter section 72 has an inner diameter larger than the small-diameter section 71. The large-diameter section 72 has an inner circumferential surface inclined along the inclined surface 62b, and holds the carbon-fiber layer 31 to the inclined surface 62b with said inner circumferential surface.

### <<End Fixation Member>>

The end fixation member 80Z is a metal tape wound, at an outer circumferential surface of the small-diameter section 71, on an outer circumferential surface of the end of the carbon-fiber layer 31, to temporarily fix the end of the carbon-fiber layer 31. The end fixation member 80Z fixes the carbon-fiber layer 31 to the small-diameter section 71 so as to restrict at least the end of the carbon-fiber layer 31 moving in the axial direction. Note that the end fixation member 80Z may not be required if the carbon-fiber layer 31 can be fixed only with the fixation member 70Z.

### <<Rotation Restriction Member>>

The rotation restriction member 90Z is a spherical metal member interposed between the recess 52a of the second metal member 50 and the groove 64b of the jig 60Z, to restrict the jig 60Z from being rotated about the axis relative to the second metal member 50. Note that the fixation member 70Z may be connected by spline connection with the second metal member 50, so as to be non-rotatable relative to each other.

### <Manufacturing Method>

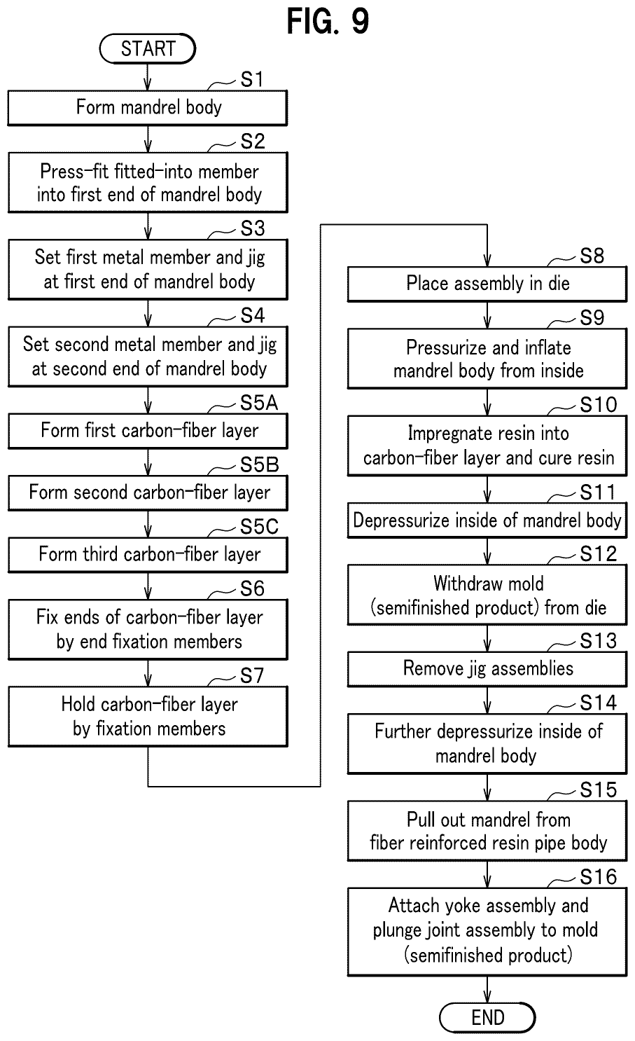

Next, a description is given of a method for manufacturing the power transmission shaft 2 with the mandrel 1A and jig assemblies 3A, 3B according to the first embodiment of the present invention, with reference to a flowchart in FIG. 9 (see FIGS. 1 to 8, as appropriate). The method for manufacturing the power transmission shaft 2 includes a step of forming a mandrel body (step S1), a step of setting a fitted-into member (step S2) executed after the step of forming a mandrel body, a step of first connection (step S3) executed after the step of setting a fitted-into member, and a step of second connection (step S4) executed after the step of first connection. The method for manufacturing the power transmission shaft 2 further includes a step of setting fibers (steps S5A to S5C) executed after the step of second connection, and a step of fixing fiber ends (step S6) executed after the step of setting fibers. The method for manufacturing the power transmission shaft 2 still further includes a holding step (step S7) executed after the step of fixing fiber ends, and a step of setting in a mold (step S8) executed after the holding step. The method for manufacturing the power transmission shaft 2 still further includes an inflating step (step S9) executed after the step of setting in a mold, and a molding step (step S10) executed after the inflating step. The method for manufacturing the power transmission shaft 2 still further includes a depressurizing step (step S11) executed after the molding step, and a withdrawing step (step S12) executed after the depressurizing step. The method for manufacturing the power transmission shaft 2 still further includes a removing step (step S13) executed after the withdrawing step, and a depressurizing step (step S14) executed after the removing step. The method for manufacturing the power transmission shaft 2 still further includes a pulling out step (step S15) executed after the depressurizing step, and a step of assembling joints (step S16) executed after the pulling out step.

Step S1 is a step of forming the resin mandrel body 10A in FIG. 1, using a molding apparatus (not shown).

In step S2 after step S1, the fitted-into member 20 is press-fitted into the first small-diameter section 13 of the mandrel body 10A. Note that step S2 only needs to be executed prior to step S10.

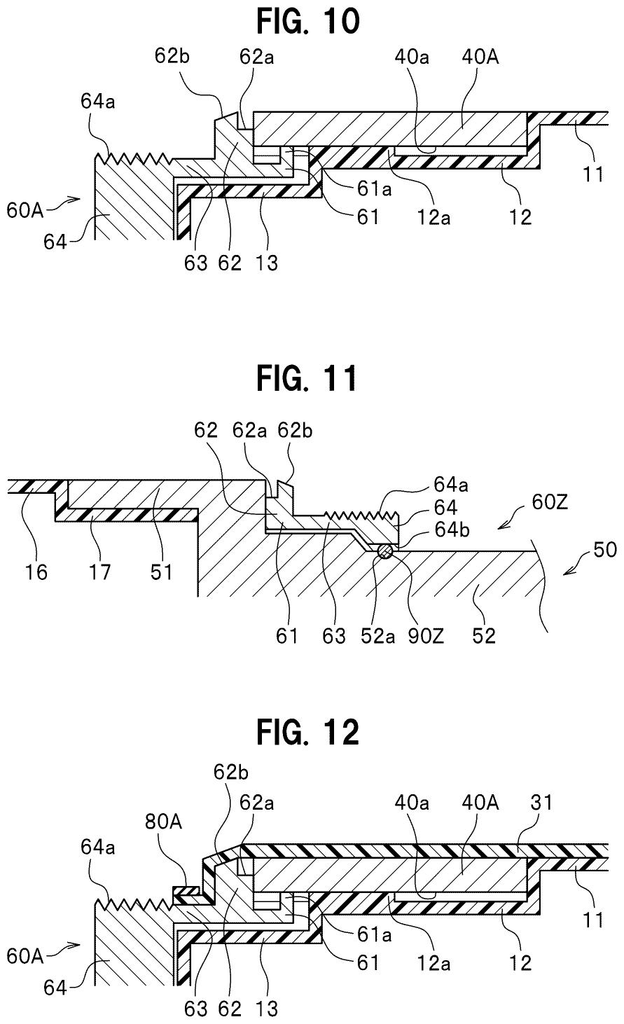

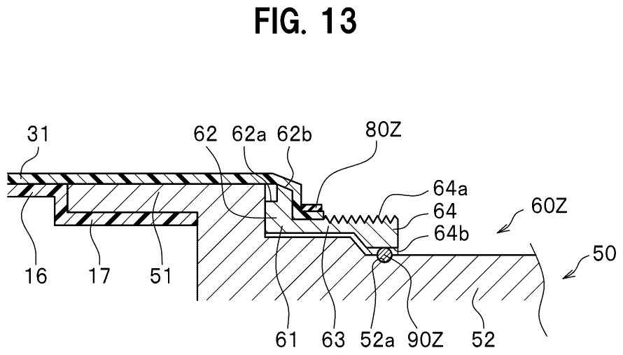

In step S3 after step S2, the first metal member (collar) 40A and jig 60A are set at the first end of the mandrel body 10A (see FIG. 10). In step S3, the first metal member 40A and jig 60A may be assembled to each other, followed by such an assembly being assembled to the mandrel body 10A. Alternatively, in step S3, the first metal member 40A may be assembled to the mandrel body 10A, followed by the jig 60A being assembled to such an assembly.

In step S4 after step S3, the second metal member 50, jig 60Z, and rotation restriction member 90Z are set at the second end of the mandrel body 10A (see FIG. 11). In step S4, the second metal member 50, jig 60Z, and rotation restriction member 90Z may be assembled to each other, followed by such an assembly being assembled to the mandrel body 10A. Alternatively, in step S4, the second metal member 50 may be assembled to the mandrel body 10A, followed by the jig 60Z and rotation restriction member 90Z being assembled to the second metal member 50. Here, an order of steps S3 and S4 can be changed as appropriate, to have step S4 executed first or both steps executed simultaneously.

In step S5A after step S4, the first carbon-fiber layer is formed on the outer circumferential surfaces of the mandrel body 10A, first metal member 40A, jig 60A, second metal member 50, and the jig 60Z. In step S5B after step S5A, the second carbon-fiber layer is formed on an outer circumferential surface of the first carbon-fiber layer on the mandrel body 10A, first metal member 40A, jig 60A, second metal member 50, and jig 60Z. In step S5C after step S5B, the third carbon-fiber layer is formed on an outer circumferential surface of the second carbon-fiber layer on the mandrel body 10A, first metal member 40A, jig 60A, second metal member 50, and jig 60Z.

In steps S5A to S5C, the carbon-fiber layer 31 is not made of resin-impregnated fibers but made of so-called raw fibers. Additionally, the carbon-fiber layer 31 is set up on the outer circumferential surfaces of the mandrel body 10A, first metal member 40A, jig 60A, second metal member 50, and jig 60Z, respectively, by multi-thread filament winding. The carbon-fiber layer 31 threaded through multi-thread filament winding makes a so-called non-crimp structure in which threads are not interwoven with each other and are independent as layers.

In step S6 after step S5, the end of the carbon-fiber layer 31 set on the outer circumferential surface of the small-diameter section 63 of the jig 60A is temporarily fixed by the end fixation member 80A, and the end of the carbon-fiber layer 31 set on the outer circumferential surface of the small-diameter section of the jig 60Z is temporarily fixed by the end fixation member 80Z.

In step S7 after step S6, the fixation member 70A is assembled to the jig 60A, to hold the carbon-fiber layer 31 between the large-diameter section 72 of the fixation member 70A and the outer circumferential surface 62b of the jig 60A, and the fixation member 70Z is assembled to the jig 60Z, to hold the carbon-fiber layer 31 between the large-diameter section 72 of the fixation member 70Z and the outer circumferential surface 62b of the jig 60Z.

In step S8 after step S7, an assembly of the mandrel 1A, first metal member 40A, second metal member 50, jig assemblies 3A and 3Z, and carbon-fiber layer 31 are placed in the molding apparatus (die) 100, as shown in FIG. 14.

In step S9 after step S8, the mandrel body 10A is inflated. As shown in FIG. 14, the molding apparatus 100 of the first embodiment has a communication path 104 provided so as to communicate with an inside of the mandrel body 10A via the flow path 20a. In step S9, a hollow in the mandrel body 10A is filled with a pressurizing fluid F (e.g., pressurized air at a temperature of 140° C. or higher) via the communication path 104 coupled with a supply device (not shown). The mandrel body 10A heated by the high-temperature pressurizing fluid F softens when the temperature thereof reaches such a temperature (transformation temperature of 80° C.) lower than the temperature at which the resin 32 cures, and is pressurized from inside by the pressurizing fluid F, to be inflated and deformed to follow an inner circumferential surface of the molding apparatus 100. Such pressurization prevents the mandrel body 10A from being deformed in a direction of being reduced in diameter due to the filled resin 32. Additionally, applying such pressure allows for reducing a filling amount of the resin 32, to prevent the fiber reinforced resin pipe body 30, as a finished product, from increasing in weight.

In step S10 after step S9, the resin 32 is supplied into the molding apparatus 100. This causes the resin 32 to be impregnated into the carbon-fiber layer 31 set on the outer circumferential surface of the mandrel body 10A. Besides, the molding apparatus 100 is heated to cure the resin 32, to form the fiber reinforced resin pipe body 30 and mold the fiber reinforced resin pipe body 30, first metal member 40A, and second metal member 50, as a single piece. The resin 32 is a thermosetting resin, for example. A die of the molding apparatus 100 of the present embodiment is divided into two or more parts. In step S10, the above-described assembly is heated and the die of the molding apparatus 100 is closed, and then the die is clamped with pressure applied to the closed die to increase pressure in the die to promote curing of the resin 32. Note that the present embodiment is described based on a configuration of the die being divided into two or more parts, so that closing the die and clamping the die are executed, but clamping the die is not essential. In a case where the die is not divided into two or more parts, such closing the die and clamping the die are not essential. The molding apparatus 100 is formed therein with a gate 101, through which the molten resin 32 is injected thereinto, and a space (resin pool 102) at an exit of the gate 101. The resin 32 injected into the molding apparatus 100 is stored in the resin pool 102 formed laterally next to the axial end of the carbon-fiber layer 31. The resin 32 stored in the resin pool 102 is moved in the axial direction of the mandrel body 10A by vacuum suction from a suction port 103 formed on an opposite side in a direction of the carbon-fiber layer 31 being aligned (closer to the outer circumferential surface of the other end in the axial direction of the carbon-fiber layer 31) to the gate 101, to impregnate the carbon-fiber layer 31. Heat is applied to the molding apparatus 100, with the resin 32 impregnated into the carbon-fiber layer 31, and additionally pressure is applied into the molding apparatus 100, to form the fiber reinforced resin pipe body 30.

In step S10, the carbon-fiber layer 31 has a load applied thereto, in the axial direction, due to flow of the resin 32. Here, the jig assemblies 3A and 3Z prevent the carbon-fiber layer 31 from being shifted in the axial direction due to the load. The jig assemblies 3A and 3Z also prevent the carbon-fiber layer 31 from being shifted in the axial direction due to a load associated with volume change caused by the resin 32 being heated (and cooled).

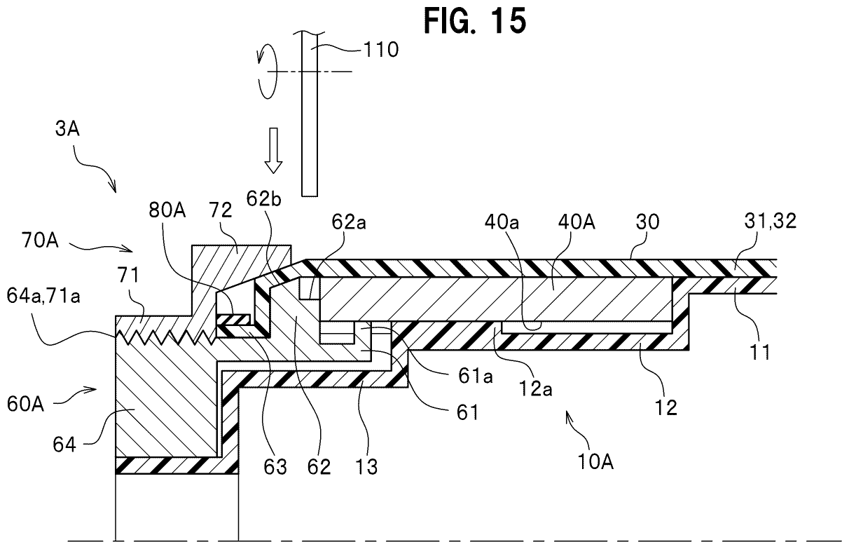

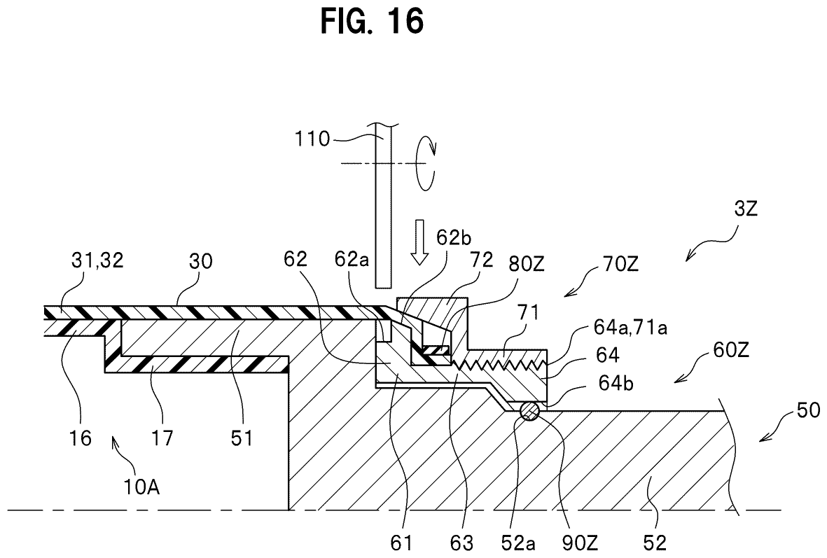

In step S11 after step S10, the mandrel body 10A is depressurized inside to about atmospheric pressure. In step S12 after step S11, the molded assembly or a semifinished product is withdrawn from the molding apparatus 100. In step S13 after step S12, the jig assemblies 3A and 3Z are removed from the fiber reinforced resin pipe body 30. In step S13, a portion of the fiber reinforced resin pipe body 30 held by a device (not shown), positioned radially on an outer side of the recess 62a in the jig assembly 3A, is cut with a cutting tool 110, as shown in FIG. 15. That is, the end of the fiber reinforced resin pipe body 30 is cut at the same position in the axial direction as the axial end of the outer circumferential surface of the first metal member 40A, around which the carbon-fiber layer 31 is wound. This causes the jig assembly 3A to be removed from the fiber reinforced resin pipe body 30 and first metal member 40A. Likewise, in step S13, a portion of the fiber reinforced resin pipe body 30, positioned radially on an outer side of the recess 62a in the jig assembly 3Z, is cut with the cutting tool 110, as shown in FIG. 16. This causes the jig assembly 3Z to be removed from the fiber reinforced resin pipe body 30 and second metal member 50.

Here, the cutting tool 110 is a tool like a side cutter circumferentially moved along the recess 62a, to cut the fiber reinforced resin pipe body 30. This allows for cutting the fiber reinforced resin pipe body 30, so as to be held by a simple device, to improve productivity.

Note that the jigs 60A and 60Z are reusable after the fiber reinforced resin pipe body 30 (cut portions), formed on the outer circumferential surfaces thereof, having been removed. The jigs 60A and 60Z may have portions of the outer circumferential surfaces thereof, around which the fiber layer 31 is wound, applied in advance with a mold release agent, to facilitate removing the fiber reinforced resin pipe body 30 (cut portions). Alternatively, the fiber reinforced resin pipe body 30 (cut portions), formed on the outer circumferential surfaces of the jigs 60A and 60Z, may be removed with a solvent from the jigs 60A and 60Z.

In step S14 after step S13, the mandrel body 10A is further depressurized inside. The mandrel body 10A of the present embodiment is made under negative pressure internally so as to be reduced in diameter (radially contracted). In step S15 after step S14, the mandrel 1A is pulled out from the fiber reinforced resin pipe body 30. Here, the first metal member 40A and second metal member 50 remain with the fiber reinforced resin pipe body 30. In step S16 after step S15, the semifinished product has the first joint member (yoke assembly) 3 attached to the first metal member 40A thereof, and has the second joint member (plunge joint assembly) 4 attached to the second metal member 50 thereof.

The jig 60A according to the first embodiment of the present invention is attached to a metal member (first metal member 40A) which is set to have carbon fibers (carbon-fiber layer 31) wound around an outer circumferential surface thereof, at an axial end of the outer circumferential surface, so as to be non-rotatable relative to each other, and includes a first small-diameter section (recess 62a) at a boundary with the outer circumferential surface, the section having a diameter smaller than the outer circumferential surface. Accordingly, the carbon fibers are wound at a distance from the first small-diameter section, so that the jig 60A allows the fiber reinforced resin pipe body 30 to be cut around the outer circumferential surface of the first small-diameter section and allows itself to be removed from the fiber reinforced resin pipe body 30 and metal member after the cutting, to implement efficiently removing unnecessary portions of the carbon fibers.

Additionally, the jig 60A has a second small-diameter section (small-diameter section 63) to which the carbon fibers are fixed, with tension toward a direction of coming away from the metal member. Accordingly, the jig 60A suitably prevents ends of the carbon fibers from being moved and entering the first small-diameter section.

In addition, a method for manufacturing the fiber reinforced resin pipe body 30 according to the first embodiment of the present invention includes: a step of winding carbon fibers (carbon-fiber layer 31) around an outer circumferential surface of a metal member (first metal member 40A) and an outer circumferential surface of the jig 60A, the jig being attached to the metal member so as to be non-rotatable relative to each other; a step of impregnating the carbon fibers with resin 32; a step of cutting the carbon fibers impregnated with the resin 32 at a radially outer side of a small-diameter section (recess 62a) formed between the outer circumferential surface of the metal member and the outer circumferential surface of the jig; and a step of removing the jig 60A from the metal member. Accordingly, the method for manufacturing the fiber reinforced resin pipe body 30 implements efficiently removing unnecessary portions of the carbon fibers.

Further, the power transmission shaft 2 according to the first embodiment of the present invention includes: a metal member (first metal member 40A); and a carbon-fiber reinforced resin pipe body 30 molded as a single piece, with carbon fibers (carbon-fiber layer 31) wound around an outer circumferential surface of the metal member and impregnated with a resin 32, wherein an end of the carbon-fiber reinforced resin pipe body 30 is cut at an axial end of the outer circumferential surface of the metal member, the surface having the carbon fibers wound therearound. Accordingly, the power transmission shaft 2 is free from carbon fibers being removed from joint members thereof, to allow for obtaining a product with improved productivity and reduced manufacturing costs.

### Modification to First Embodiment

Next, a description is given of a modification to the jig assembly according to the first embodiment of the present invention, focusing on differences from the jig assembly 3A according to the first embodiment.

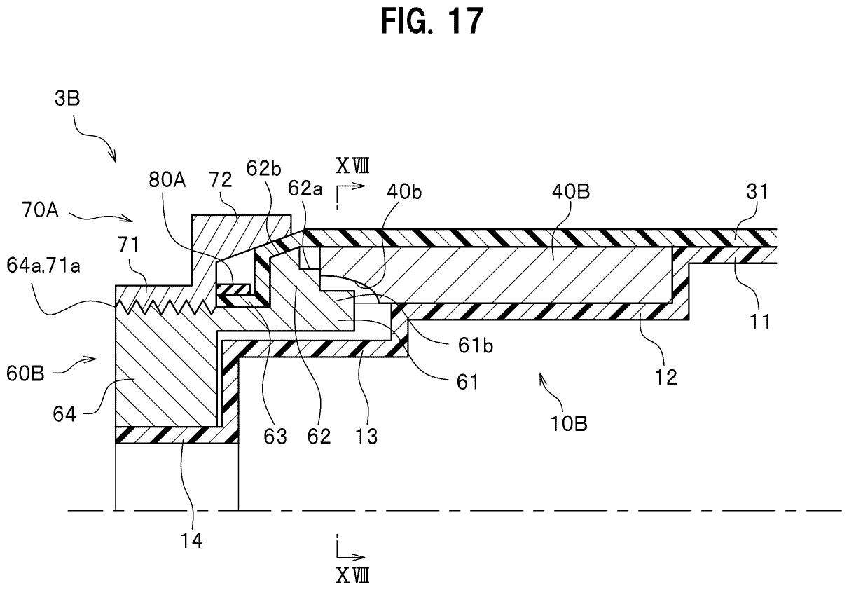

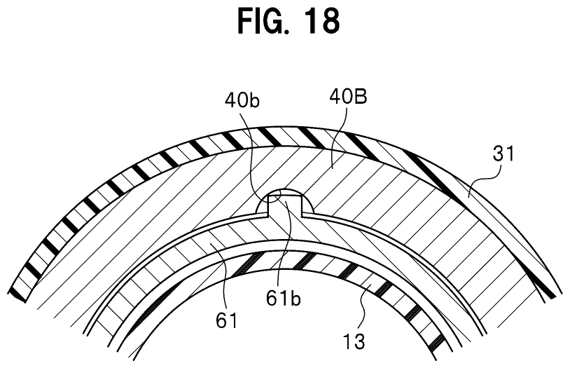

As shown in FIGS. 17 and 18, a mandrel body 10B according to a modification to the first embodiment of the present invention does not include the male spline 12a in the first stepped section 12. A first metal member 40B is formed in an inner circumferential surface thereof with a recess 40b instead of the female spline 40a. The recess 40b is formed to open at an axial end of the first metal member 40B, the end being next to a jig 60B.

### <Jig Assembly>

A jig assembly 3B according to a modification to the first embodiment of the present invention includes the jig 60B in place of the jig 60A.

The jig 60B is formed, on an outer circumferential surface of the first end section 61, with a protrusion 61b. The jig 60B is attached to the first metal member 40B, so as to be non-rotatable relative to each other, with the protrusion 61b fitted into the recess 40b.

The jig assembly 3B according to the modification to the first embodiment of the present invention restricts the jig 60B from being rotated relative to the first metal member 40B, with a simple structure of the protrusion 61b and recess 40b provided circumferentially at a single point.

### Second Embodiment

Next, a description is given of a jig assembly according to a second embodiment of the present invention, focusing on differences from the jig assembly 3A according to the first embodiment.

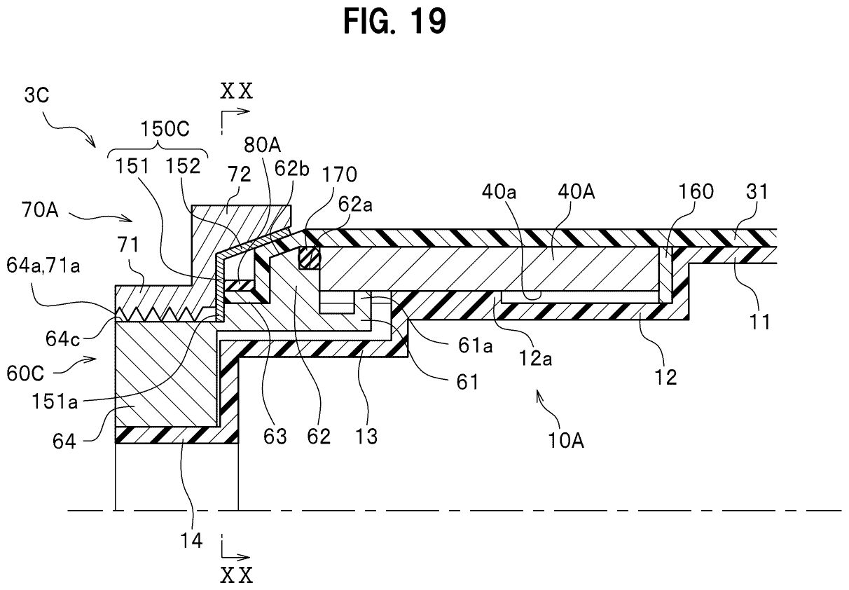

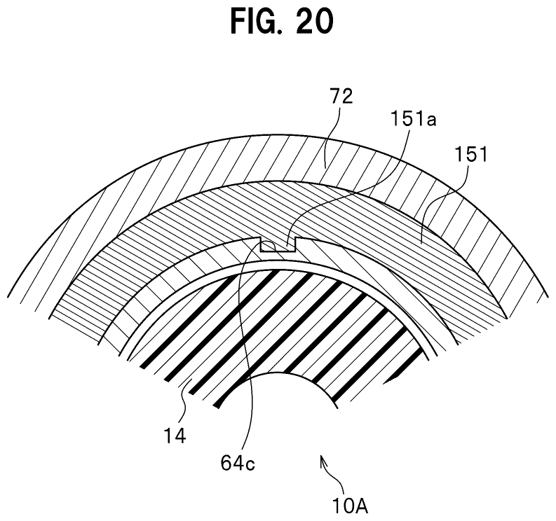

As shown in FIGS. 19 and 20, a jig assembly 3C according to the second embodiment of the present invention includes a jig 60C in place of the jig 60A, and further includes a washer member 150C, a seal member 160, and a ring member 170.

### <Jig>

The jig 60C is formed, on an outer circumferential surface of the second end section 64, with a concave portion 64c extending in the axial direction. The concave portion 64c is open at an end surface of the second end section 64.

### <Washer Member>

The washer member 150C is a metal washer interposed between the jig 60A and the fixation member 70A. The washer member 150C includes, as a single member, a radially inner portion 151 and a radially outer portion 152. The washer member 150C is formed in an inner circumferential surface thereof with a convex portion 151a to be engaged with the concave portion 64c. The washer member 150C is attached to the jig 60A, so as to be non-rotatable about the axis relative to each other, with the convex portion 151a engaged with the concave portion 64c. The radially outer portion 152 of the washer member 150C is inclined to correspond to the inclined surface 62b of the jig 60A, and is interposed between the carbon-fiber layer 31 and the large-diameter section 72 of the fixation member 70A.

### <Seal Member>

The seal member 160 is an annular resin member to be fitted onto the second stepped section 12 of the mandrel body 10A. The seal member 160 closes the female spline 40a at an end of the first metal member 40A, the end being next to the large-diameter section 11.

### <Ring Member>

The ring member 170 is an annular resin member accommodated in an annular groove defined by the end surface of the first metal member 40A and the recess 62a of the large-diameter section 62. The ring member 170 is a resin flow prevention ring placed to closely contact the end surface of the first metal member 40A before the resin 32 is filled into the molding apparatus 100 and impregnated into the carbon-fiber layer 31, to prevent the resin 32 from entering the groove and being cured. The ring member 170 can be suitably formed of a material (rubber, urethane foam, and the like) softer than the first metal member 40A.

The jig 60C according to the second embodiment of the present invention has the resin flow prevention ring (ring member 170) placed on the first small-diameter section. Accordingly, the jig assembly 3C facilitates cutting a portion of the fiber reinforced resin pipe body 30 on a radially outer side of the first small-diameter section, to implement efficiently removing unnecessary portions of the carbon fibers and reducing waste from the resin 32.

### Modification to Second Embodiment

Next, a description is given of a jig assembly according to a modification to the second embodiment of the present invention, focusing on differences from the jig assembly 3C according to the second embodiment.

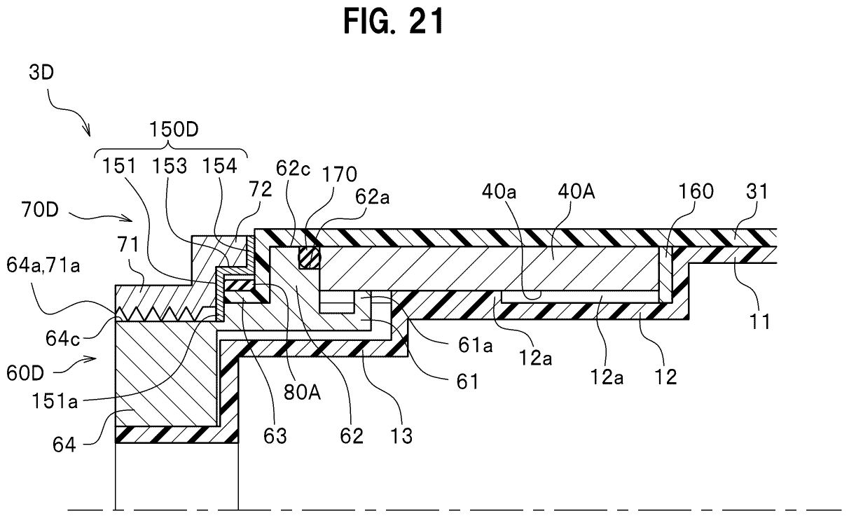

As shown in FIG. 21, a jig assembly 3D according to a modification to the second embodiment of the present invention includes a jig 60D, a fixation member 70D, and a washer member 150D in place of the jig 60C, fixation member 70A, and washer member 150C.

### <Jig>

The large-diameter section 62 of the jig 60D has a uniform diameter surface 62c axially having a uniform diameter, in place of the inclined surface 62b.

### <Washer Member>

The washer member 150D includes, as a single member, a radially inner portion 151, an axially-extending radially-inner portion 153, and a radially outer portion 154. The radially outer portion 154 is closer to the first metal member 40 than the radially inner portion 151, and is interposed between the carbon-fiber layer 31 and an axial end surface of the large-diameter section 72 of the fixation member 70D.

The large-diameter section 72 of the fixation member 70D of the present embodiment holds the carbon-fiber layer 31 to a radially extending end surface at a boundary between the large-diameter section 62 and small-diameter section 63 of the jig 60D, with said axial end surface via the washer member 150D.

### Third Embodiment

Next, a description is given of a jig assembly according to a third embodiment of the present invention, focusing on differences from the jig assembly 3A according to the first embodiment.

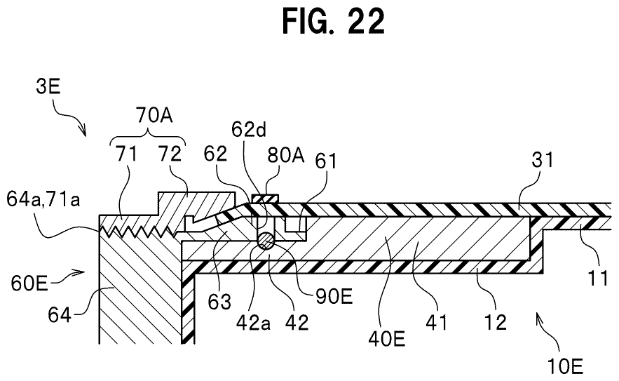

As shown in FIG. 22, a mandrel body 10E according to the third embodiment of the present invention has a structure in which the second stepped section 13 is omitted. Additionally, a first metal member 40E according to the third embodiment of the present invention includes, as a single member, a large-diameter section 41 and a small-diameter section 42.

A jig assembly 3E according to the third embodiment of the present invention includes a jig 60E and a rotation restriction member 90E, in place of the jig 60A.

### <Jig>

The first end section 61, large-diameter section 62, and small-diameter section 63 of the jig 60E are fitted onto the small-diameter section 42 of the first metal member 40E. The large-diameter section 62 is formed therein with a hole 62d penetrating therethrough in the radial direction.

### <Rotation Restriction Member>

The rotation restriction member 90E is a spherical metal member interposed between the recess 42a formed in the outer circumferential surface of the small-diameter section 42 of the first metal member 40E and the hole 62d in the jig 60E, to restrict the jig 60E from being rotated about the axis relative to the first metal member 40E. Note that the jig 60E may be non-rotatably coupled by spline connection with the first metal member 40E.

### <Manufacturing Method>

Next, a description is given of a method for manufacturing the power transmission shaft 2 using a mandrel 1E and the jig assembly 3E according to the third embodiment of the present invention, focusing on differences from the first embodiment.

In step S3, the first metal member 40E and jig 60E may be assembled to each other, followed by the rotation restriction member 90E being placed in the recess 42a through the hole 62d, and then such an assembly may be assembled to the mandrel body 10E. Alternatively, in step S3, the first metal member 40E may be assembled to the mandrel body 10E, followed by the jig 60E being assembled to such an assembly, and then the rotation restriction member 90E may be placed in the recess 42a through the hole 62d.

In step S6, the end of the carbon-fiber layer 31 set on the outer circumferential surface of the large-diameter section 62 (hole 62d) of the jig 60E is temporarily fixed by the end fixation member 80A.

In step S13, the cutting tool 110 cuts a portion of the fiber reinforced resin pipe body 30, positioned on a radially outer side of the small-diameter section 61 of the jig assembly 3E.

Hereinabove, the embodiments of the present invention have been described, but the present invention is not limited to these and can be modified as appropriate within the scope thereof. For example, the fluid flowing into and filling the mandrel body 10A or 10E may be used to heat the thermosetting resin set on the outer circumferential surface of the mandrel body 10A or 10E in order to cure the resin, in addition to pressurizing the mandrel body 10A or 10E inside. Note that in a case where the fluid is a pressurizing fluid which is not used for heating, the thermosetting resin is heated by another heat source.

As another example, the carbon-fiber layer 31 may have a so-called crimp structure in which threads are interwoven with each other. As a modification to the embodiments, fibers are not limited to carbon fibers and may be any fibers (such as glass fibers and cellulose fibers) to reinforce a resin layer.

### LEGEND FOR REFERENCE NUMERALS

1A, mandrel; 3A, 3B, 3C, 3D, 3E, 3Z, jig assembly; 10A, 10E, mandrel body; 30, fiber reinforced resin pipe body (resin pipe body, carbon-fiber reinforced resin pipe body); 40A, first metal member (metal member); 50, second metal member (metal member); 60A, 60B, 60C, 60D, 60E, 60Z, jig (carbon-fiber fixation jig); 70A, 70D, 70Z, fixation member; 80A, 80Z, end fixation member; and 150D, 150E, washer member.

1. A carbon-fiber fixation jig to be attached to a metal member, which is set to have carbon fibers wound around an outer circumferential surface thereof, at an axial end of said outer circumferential surface, so as to be non-rotatable relative to each other,
wherein the jig includes a first small-diameter section at a boundary with said outer circumferential surface, the section having a diameter smaller than said outer circumferential surface.

2. The carbon-fiber fixation jig according to claim 1, wherein
the first small-diameter section has a resin flow prevention ring placed thereon.

3. The carbon-fiber fixation jig according to claim 1, wherein
the jig has a second small-diameter section to which the carbon fibers are fixed, with tension toward a direction of coming away from the metal member.

4. A method for manufacturing a carbon-fiber reinforced resin pipe body, the method comprising:
a step of winding carbon fibers around an outer circumferential surface of a metal member and an outer circumferential surface of a jig, the jig being attached to the metal member so as to be non-rotatable relative to each other;
a step of impregnating the carbon fibers with resin;
a step of cutting the carbon fibers impregnated with the resin at a radially outer side of a small-diameter section formed between the outer circumferential surface of the metal member and the outer circumferential surface of the jig; and
a step of removing the jig from the metal member.

5. A power transmission shaft comprising:
a metal member; and
a carbon-fiber reinforced resin pipe body molded as a single piece, with carbon fibers wound around an outer circumferential surface of the metal member and impregnated with resin,
wherein an end of the carbon-fiber reinforced resin pipe body is cut at an axial end of the outer circumferential surface of the metal member, the surface having the carbon fibers wound therearound.

6. The carbon-fiber fixation jig according to claim 2, wherein
the jig has a second small-diameter section to which the carbon fibers are fixed, with tension toward a direction of coming away from the metal member.
